(19) United States
(12) Patent Application Publication
(10) Pub. No.: US 2023/0354930 A1
(43) Pub. Date: Nov. 9, 2023

(54) MASK AND METHOD FOR PRODUCING SAME

(71) Applicant: ZUIKO CORPORATION, Ibaraki-shi, Osaka (JP)

(72) Inventor: Toyoshi UMEBAYASHI, Ibaraki-shi, Osaka (JP)

(21) Appl. No.: 17/911,582

(22) PCT Filed: Mar. 15, 2021
(86) PCT No.: PCT/JP2021/010429

§ 371 Date: Sep. 14, 2022

(30) Foreign Application Priority Data
Apr. 3, 2020 (JP) 2020-067762

(51) Int. Cl. A41D 13/11; A41H 3/00

(52) U.S. Cl. CPC A41D 13/1161; A41H 3/00

(57) ABSTRACT

Provided are: a mask which can be manufactured with less waste of material and at a high speed; and a method for manufacturing same. A mask body has first and second peripheral edges extending in a first direction and third and fourth peripheral edges extending in a second direction intersecting with the first direction. A pair of ear hooking parts has (i) a pair of extension parts extending along the first and second peripheral edges of the mask body, with one end of each extension part bonded to a side edge part of the mask body; and (ii) a connecting part distinct from the pair of extension parts, the connecting part being bonded to the corresponding other ends of the pair of extension parts and extending in the second direction.

### TECHNICAL FIELD

The present invention relates to a mask and a method for producing same, and more specifically, relates to a mask where a pair of ear hooking parts are bonded to a mask body and a method for producing same.

### BACKGROUND ART

Conventionally, a mask has been proposed where a pair of sheet-like ear hooking parts are bonded to a mask body. For example, FIG. 11 is a plan view of such a mask 110, and shows a condition where the mask 110 in unused state is viewed from the skin surface side. As shown in FIG. 11, in the mask 110, an ear hooking sheet 130a constituting a pair of ear hooking parts 130 is bonded to a mask body 120.

The pair of ear hooking parts 130 each have a bonded part 131 and an annular part 132. The bonded part 131 is bonded to an end area 121 of the mask body 120 through bonding points 122 by fusing. The annular parts 132 of the pair of ear hooking parts 130 are joined together at a joined part 134. Ear hooking holes 133 are formed inside the bonded parts 131 and the annular parts 132. When the mask 110 is used, the pair of ear hooking parts 130 are separated at the joined part 134, and ears are inserted in the ear hooking holes 133.

FIG. 12 is an explanatory view of a process of producing the mask 110. As shown in FIG. 12, the mask bodies 120 are conveyed in the direction of the arrow 140 while being held on a sheet holding surface 142 of a holding roll 141. At the same time, a sheet holding surface 124 of a die-cutter 123 conveys a sheet continuous body 121b where parts to become the ear hooking sheets 130a are formed, in the direction indicated by the arrow 220. Then, the mask bodies 120 on the holding roll 141 and the parts of the sheet continuous body 121b to become the ear hooking sheets 130a are placed one on another, bonded together, and then, cut into individual masks 110 (for example, see Patent Literature 1).

### CITATION LIST

### Patent Literature

[Patent Literature 1] Japanese Patent No. 5762804

### SUMMARY OF THE INVENTION

### Problem to be Solved by the Invention

However, in a case where the ear hooking parts are formed in a sheet form, the ear hooking holes are necessarily formed by cutting away parts of the sheet to provide the ear hooking holes, which causes a problem in that the material is wasted.

In addition, the sheet continuous body where the unnecessary parts are cut away to form the ear hooking parts is difficult to be conveyed at a high speed. This hinders high-speed mask production.

In view of such circumstances, a problem to be solved by the invention is to provide a mask which can be produced with less waste of material and at a high speed, and a method for producing same.

### Means for Solving the Problem

To solve the above-mentioned problem, the present invention provides a mask structured as follows:

A mask is provided with: (a) a mask body having first and second peripheral edges extending in a first direction and third and fourth peripheral edges extending in a second direction intersecting with the first direction; (b) a first ear hooking part bonded to a first side edge part adjoining the third peripheral edge of the mask body; and (c) a second ear hooking part bonded to a second side edge part adjoining the fourth peripheral edge of the mask body. The first ear hooking part has: (i) first and second extension parts one ends of which are bonded to the first side edge part and that extend in the first direction along the first peripheral edge or the second peripheral edge at a distance from each other in the second direction; (ii) a first connecting part distinct from the first and second extension parts, the first connecting part being bonded to the other ends of the first and second extension parts and extending in the second direction. The second ear hooking part has: (i) third and fourth extension parts one ends of which are bonded to the second side edge part and that extend in the first direction along the first peripheral edge or the second peripheral edge at a distance from each other in the second direction; and (ii) a second connecting part distinct from the third and fourth extension parts, the second connecting part being bonded to the other ends of the third and fourth extension parts and extending in the second direction. A first ear hooking hole surrounded by the first and second extension parts and the first connecting part of the first ear hooking part is defined. A second ear hooking hole surrounded by the third and fourth extension parts and the second connecting part of the second ear hooking part is defined.

According to the above-described structure, since the first and second extension parts and the first connecting part are distinct from each other and the third and fourth extension parts and the second connecting part are distinct from each other, an ear hooking part continuous body for forming the first and second ear hooking parts can be structured so as to be conveyable at a high speed and the mask can be produced at a high speed. Moreover, since it is unnecessary to cut the parts corresponding to the entire ear hooking holes from the material, waste of material can be reduced.

Preferably, in the mask, in unused state, (a) the other end of the first extension part of the first ear hooking part and the other end of the third extension part of the second ear hooking part separably connect with each other in a center of the mask body in the first direction, (b) the other end of the second extension part of the first ear hooking part and the other end of the fourth extension part of the second ear hooking part separably connect with each other in the center of the mask body in the first direction, and (c) the first connecting part of the first ear hooking part and the second connecting part of the second ear hooking part separably connect with each other in the center of the mask body in the first direction. When the mask is used, the first and second ear hooking parts are separated in the center of the mask body in the first direction.

In this case, the mask can be produced continuously and efficiently.

Preferably, in the mask, in unused state, the first and second ear hooking parts are disposed on a non-skin surface side of the mask body.

In this case, since the mask can be put on without the skin surface side of the mask being touched, the mask is hygienic.

Preferably, in the mask, in unused state, when viewed from a third direction vertical to the first and second directions, ends, on the same side in the second direction, of the first connecting part of the first ear hooking part and the second connecting part of the second ear hooking part protrude from the mask body.

In this case, since the ear hooking parts are easily separated from the mask body, the mask is easy to put on.

Preferably, in the mask, in unused state, (a) the first connecting part of the first ear hooking part is disposed on a side, opposite to the mask body, of the first and second extension parts of the first ear hooking part, and (b) the second connecting part of the second ear hooking part is disposed on a side, opposite to the mask body, of the third and fourth extension parts of the second ear hooking part.

In this case, when the mask is in unused state, no space is formed between the first to fourth extension parts and the mask body. Moreover, in the mask, in unused state, since one ends of the first to fourth extension parts are covered by the first and second connecting parts, the external appearance is simple.

Preferably, in the mask, in unused state, the first and second ear hooking parts connect with each other in the center of the mask body in the first direction. In the mask, in used state, the first and second ear hooking parts are separated in the center of the mask body in the first direction, and folded to the outside of the mask body in the first direction.

In this case, when the mask is worn, since the folded parts of the first to fourth extension parts tend to spread, the first and second side edge parts of the mask body are pressed against the face, so that the mask is easy to closely adhere to the face.

Preferably, the first and second extension parts of the first ear hooking part and the third and fourth extension parts of the second ear hooking part are each formed of a member where an elastic member stretchable in the first direction is sandwiched between two nonwoven fabric sheets or between one folded nonwoven fabric sheet.

In this case, the mask body can be made to closely adhere to the face by using the tension of the elastic member.

Moreover, to solve the above-mentioned problem, the present invention provides a method for producing a mask structured as follows:
A mask producing method is a method for producing a mask comprising: (a) a mask body having first and second peripheral edges extending in a first direction and third and fourth peripheral edges extending in a second direction intersecting with the first direction; (b) a first ear hooking part bonded to a first side edge part adjoining the third peripheral edge of the mask body; and (c) a second ear hooking part bonded to a second side edge part adjoining the fourth peripheral edge of the mask body, wherein the first and second ear hooking parts are formed of: (i) first and second extension members that extend along the first peripheral edge or the second peripheral edge at a distance from each other in the second direction, one ends of which are bonded to the first side edge part of the mask body and the other ends of which are bonded to the second side edge part of the mask body; and (ii) a connecting member distinct from the first and second extension members, the connecting member extending in the second direction in a center of the mask body in the first direction and being bonded to the first and second extension members, and first and second ear hooking holes surrounded by the first and second extension members and the connecting member are defined. The mask producing method is provided with: (i) a first process in which a mask body continuous body having first and second side edges parallel to each other and where the first peripheral edge of the mask body is formed by the first side edge, the second peripheral edge of the mask body is formed by the second side edge and by cutting in a direction intersecting with the first and second side edges, the third peripheral edge of the mask body and the fourth peripheral edge of another mask body are formed simultaneously, is conveyed in a direction in which the first and second side edges extend; (ii) a second process in which first and second extension part continuous bodies each being continuous in one direction and where by cutting in a direction intersecting with the one direction, the one ends of the first and second extension members and the other ends of other first and second extension members are formed simultaneously, are conveyed in the one direction parallel to each other at predetermined intervals; (iii) a third process in which a plurality of connecting members are bonded to the first and second extension part continuous bodies at a predetermined interval in a direction in which the first and second extension part continuous bodies are conveyed, so as to straddle between the first and second extension part continuous bodies being conveyed, thereby forming an ear hooking part continuous body; (iv) a fourth process in which the ear hooking part continuous body and the mask body continuous body both being conveyed are placed one on another so that the first extension part continuous body of the ear hooking part continuous body is along the first side edge of the mask body continuous body and the second extension part continuous body of the ear hooking part continuous body is along the second side edge of the mask body continuous body and the first and second extension part continuous bodies of the ear hooking part continuous body and the mask body continuous body are bonded together in the middle between the adjoining connecting members, thereby forming a mask continuous body; and (v) a fifth process in which the mask continuous body being conveyed is cut in a direction intersecting with the direction in which the mask continuous body is conveyed, thereby obtaining individual masks.

According to the above-described method, the ear hooking part continuous body where the first and second extension part continuous bodies are continuous can be conveyed at a high speed and accordingly, the mask can be produced at a high speed. Since the ear hooking part continuous body can be formed without cutting away the parts corresponding to the entire ear hooking holes, waste of material can be reduced.

Preferably, in the third process, the first and second extension part continuous bodies having elastic stretchability are conveyed in a state of being stretched in the direction in which the first and second extension part continuous bodies are conveyed, and in the fourth process, the first and second extension part continuous bodies of the ear hooking part continuous body are conveyed in a state of being contracted in the direction in which the first and second extension part continuous bodies are conveyed.

In this case, a mask can be produced in which the first and second extension members have stretchability.

Preferably, the first extension part continuous body has: between two nonwoven fabric sheets continuous in the direction in which the first extension part continuous body is conveyed or one folded nonwoven fabric sheet; and a first elastic member sandwiched between the two nonwoven fabric sheets or between the one folded nonwoven fabric sheet and stretchable and continuous in the direction in which the first extension part continuous body is conveyed. The second extension part continuous body has: between other two nonwoven fabric sheets continuous in the direction in which the second extension part continuous body is conveyed or other one folded nonwoven fabric sheet; and a second elastic member sandwiched between the two other nonwoven fabric sheets or between the other one folded nonwoven fabric sheet and stretchable and continuous in the direction in which the second extension part continuous body is conveyed.

In this case, the first and second extension member continuous bodies are conveyed at a higher speed than when the first and second extension part continuous bodies are formed of only an elastic member, so that the mask can be produced at a high speed.

Preferably, the first extension part continuous body has: between two nonwoven fabric sheets continuous in the direction in which the first extension part continuous body is conveyed or one folded nonwoven fabric sheet; and a first elastic member sandwiched between the two nonwoven fabric sheets or between the one folded nonwoven fabric sheet and continuous in the direction in which the first extension part continuous body is conveyed. The second extension part continuous body has: between other two nonwoven fabric sheets continuous in the direction in which the second extension part continuous body is conveyed or other one folded nonwoven fabric sheet; and a second elastic member sandwiched between the two other nonwoven fabric sheets or between the other one folded nonwoven fabric sheet and continuous in the direction in which the second extension part continuous body is conveyed. Prior to the fourth process, the first extension part continuous body is drawn in the direction in which the first extension part continuous body is conveyed, and is provided with stretchability in the direction in which the first extension part continuous body is conveyed, and the second extension part continuous body is drawn in the direction in which the second extension part continuous body is conveyed, and is provided with stretchability in the direction in which the second extension part continuous body is conveyed.

In this case, it is unnecessary that the first and second elastic members of the first and second extension part continuous bodies be in stretched state in the second and third processes.

Preferably, the first and second extension part continuous bodies conveyed in the second process are formed as follows: The first and second elastic members are sandwiched between the continuous two nonwoven fabric sheets or between one nonwoven fabric sheet folded and continuous in a direction of a folding line, at a distance from each other so as to be continuous in a direction in which the two nonwoven fabric sheets or the one nonwoven fabric sheet is continuous, thereby forming a common continuous body, and the common continuous body is cut in the direction in which the first and second elastic members are continuous between the first and second elastic members so as to be divided into the first extension part continuous body including the first elastic member and the second extension part continuous body including the second elastic member.

In this case, the first and second extension part continuous bodies can be formed more efficiently than when the first and second extension part continuous bodies are formed separately.

Preferably, the first and second elastic members are rubber threads or shrink films.

In this case, the first and second extension member having stretchability can be easily formed.

Preferably, the connecting member is formed by cutting a continuous sheet into a strip shape.

In this case, waste of the material forming the connecting member can be reduced.

Preferably, the connecting member is previously cut in a curved shape so that an external shape on both sides of the connecting member in the first direction is close to each other in a middle part in the second direction.

In this case, compared with when the external shape on both sides of the connecting member in the first direction is linear, the first and second ear hooking parts more easily fit the ears, so that the mask does not readily come off.

Preferably, after the third process and prior to the fourth process, in a middle part of the connecting member in a direction in which the connecting member is conveyed together with the first and second extension part continuous bodies, a cut is formed in a direction orthogonal to the direction.

In this case, the first and second ear hooking parts of the mask can be easily separated along the cut.

Preferably, the cut includes a perforation formed in a middle part of the connecting member in the second direction.

In this case, starting the cutting at the perforation of the connecting member, the first and second ear hooking parts can be easily separated.

### Effects of the Invention

According to the present invention, waste of material can be reduced, and the mask can be produced at a high speed.

### BRIEF DESCRIPTION OF THE DRAWINGS

FIG. 1 is a front view of a mask in unused state (first embodiment).

FIG. 2 is a rear view of the mask in unused state (first embodiment).

FIGS. 3(a) to 3(c) are schematic cross-sectional views of the mask in unused state (first embodiment).

FIG. 4(a) is a front view of the mask in used state, and FIG. 4(b) is a schematic cross-sectional view of the mask in used state (first embodiment).

FIGS. 5(a) to 5(d) are explanatory views of a process of forming first and second extension part continuous bodies (first embodiment).

FIGS. 6(a) to 6(d) are explanatory views of a process of forming an ear hooking part continuous body (first embodiment).

FIGS. 7(a) to 7(d) are explanatory views of a process of forming a mask continuous body to obtain individual masks (first embodiment).

FIGS. 8(a) to 8(c) are explanatory views of a process of forming a connecting member (first embodiment).

FIGS. 9(a) to 9(f) are explanatory views of a process of forming the first and second extension part continuous bodies (first modification).

FIGS. 10(a) to 10(c) are explanatory views of the process of forming the first and second extension part continuous bodies (first modification).

FIG. 11 is a plan view of the mask (first conventional example).

FIG. 12 is an explanatory view of the process of producing the mask (first conventional example).

### MODE FOR CARRYING OUT THE INVENTION

Hereinafter, an embodiment of the present invention will be described with reference to the drawings.

### First Embodiment

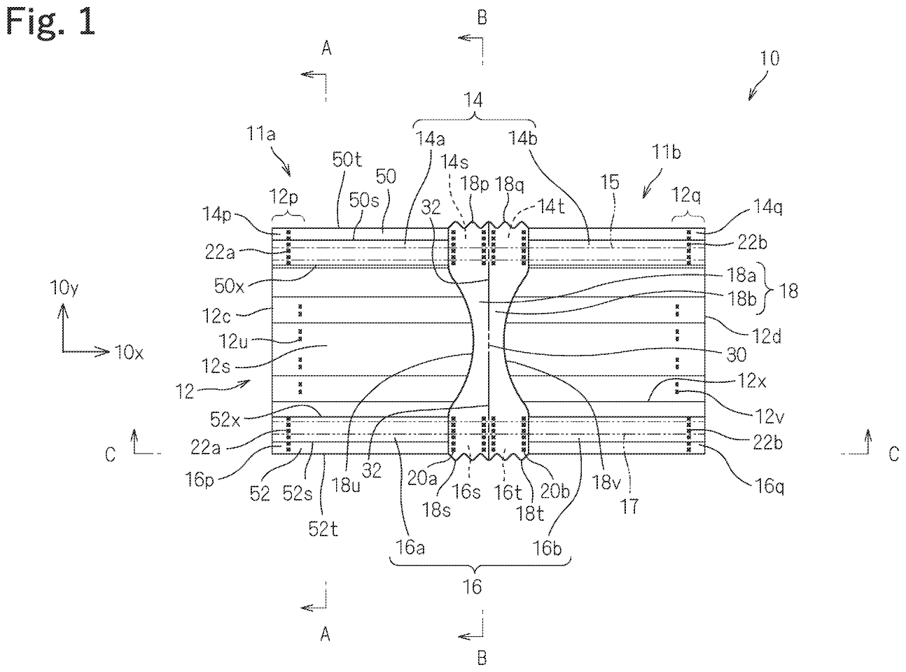

A mask and a method for producing same according to a first embodiment will be described with reference to FIGS. 1 to 8(c).

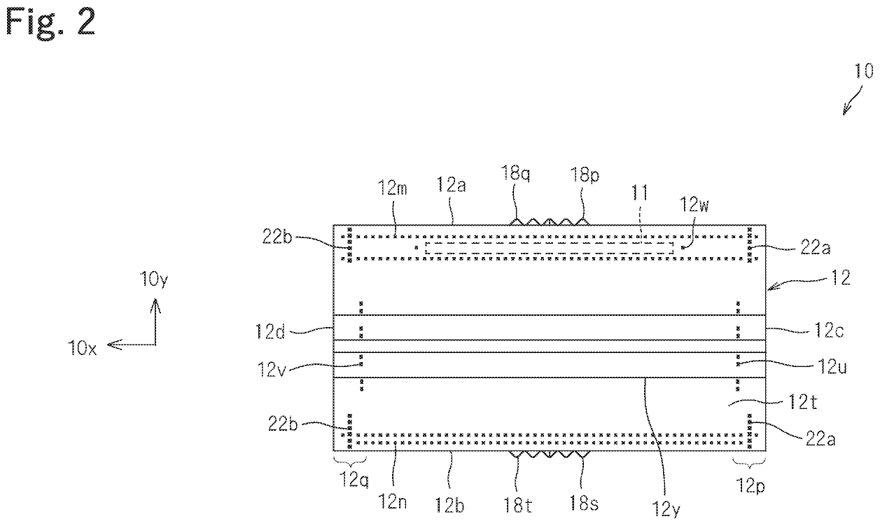

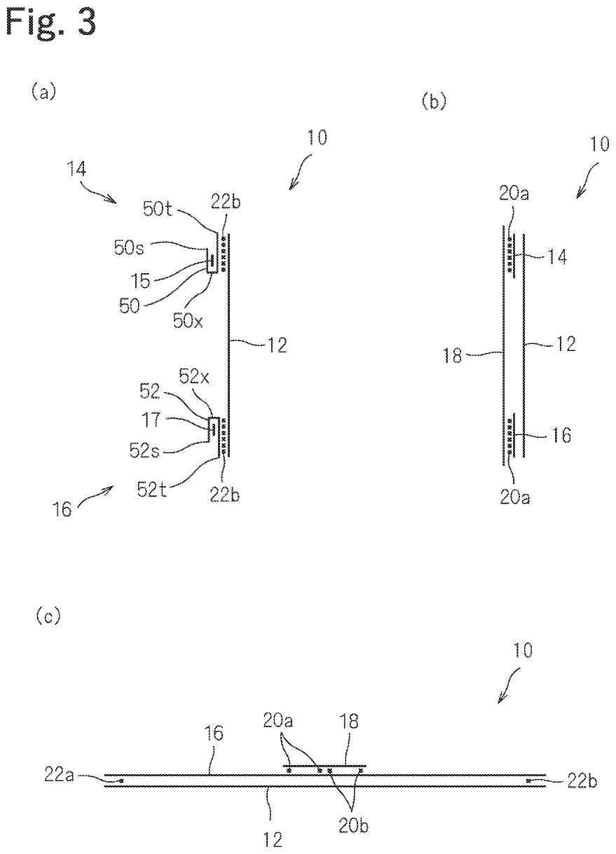

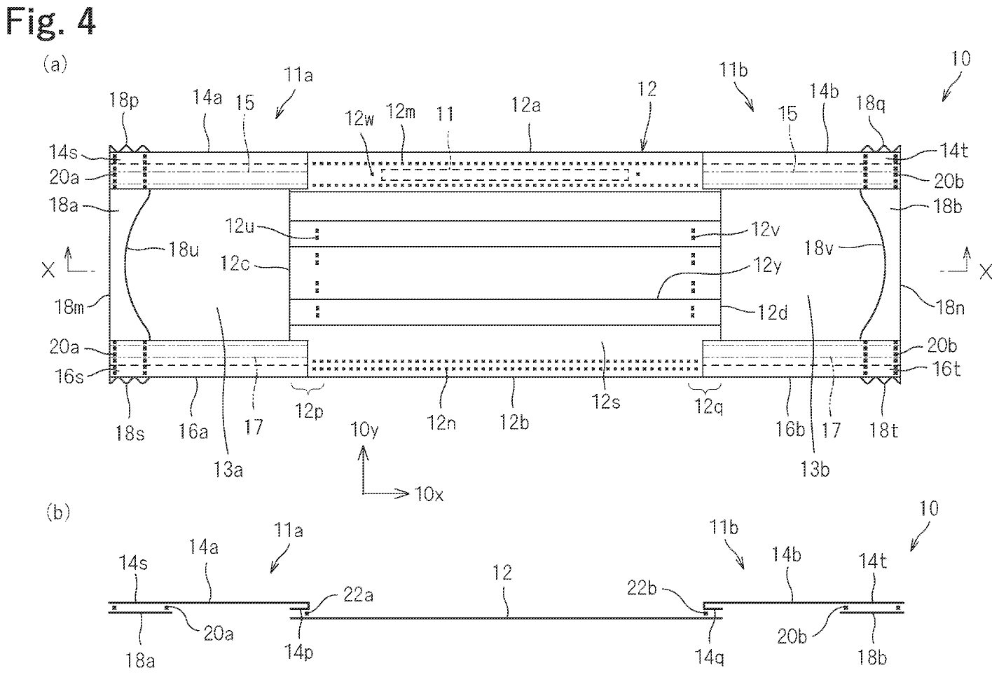

First, a mask 10 of the first embodiment will be described with reference to FIGS. 1 to 4(b). FIG. 1 is a front view of the mask 10 in unused state viewed from the non-skin surface side. FIG. 2 is a rear view of the mask 10 in unused state viewed from the skin surface side. FIG. 3(a) is a schematic view conceptually showing the structure of a cross section along line A-A of FIG. 1. FIG. 3(b) is a schematic view conceptually showing the structure of a cross section along line B-B of FIG. 1. FIG. 3(c) is a schematic view conceptually showing the structure of a cross section along line C-C of FIG. 1. FIG. 4(a) is a front view of the mask 10 in used state viewed from the non-skin surface side. FIG. 4(b) is a schematic view conceptually showing the structure of a cross section along line X-X of FIG. 4(a).

As shown in FIGS. 1 to 3(c), in the mask 10, in unused state, first and second ear hooking parts 11a, 11b are disposed on a non-skin surface 12s of a mask body 12. As shown in FIGS. 4(a) and (b), when the mask 10 is in used state, the first and second ear hooking parts 11a, 11b are separated.

As shown in FIGS. 1 to 4(b), the mask body 12 has first and second peripheral edges 12a, 12b extending in the horizontal direction of the mask 10 (that is, a first direction 10x) and third and fourth peripheral edges 12c, 12d extending in the vertical direction of the mask 10 (that is, a second direction 10y intersecting with the first direction 10x).

The mask body 12 is formed, for example, by using a composite sheet where a filter sheet is laminated between two nonwoven fabric sheets. The composite sheet is folded so as to be pleated in such a manner that a plurality of folding lines 12x, 12y extending in the first direction 10x are aligned with their positions being shifted in the second direction 10y, and body bonded parts 12m, 12n, 12u, 12v and 12w (see FIG. 2) are formed along the first to fourth peripheral edges 12a to 12d by heat sealing (heat welding, heat fusing), ultrasonic sealing (ultrasonic welding, ultrasonic fusing) or the like. In the composite sheet, the layers are bonded and intergraded with one another at the body bonded parts 12m, 12n, 12u, 12v and 12w. Inside the mask body 12, a plastically deformable wire-like fitting member 11 is disposed so as to extend along the first peripheral edge 12a. The fitting member 11 is surrounded by the body bonded parts 12m and 12w.

When the mask 10 is used, the distance between the first and second peripheral edges 12a, 12b is increased in the vicinity of the center in the first direction 10x, the pleats formed on the mask body 12 are developed to bring the mask body 12 into a semicircular three-dimensional shape, and the fitting member 11 is deformed so as to follow the protruding shape of the nose, whereby the mask body 12 is closely fitted to the face.

It is only necessary that the mask body 12 be formed appropriately by using an appropriate sheet. For example, the mask body 12 may be formed of only one sheet. The sheet constituting the mask body 12 may be unpleated.

The first ear hooking part 11a has first and second extension parts 14a, 16a extending in the first direction 10x at a distance from each other in the second direction 10y and a first connecting part 18a extending in the second direction 10y. The first extension part 14a extends along the first peripheral edge 12a of the mask body 12, and the second extension part 16a extends along the second peripheral edge 12b of the mask body 12. One ends 14p, 16p of the first and second extension parts 14a, 16a are bonded, through a first side edge bonded part 22a, to a first side edge part 12p adjoining the third peripheral edge 12c of the mask body 12. To the other ends 14s, 16s of the first and second extension parts 14a, 16a, the first connecting part 18a is bonded through a first central bonded part 20a. The first connecting part 18a is distinct from the first and second extension parts 14a, 16a.

The second ear hooking part 11b has third and fourth extension parts 14b, 16b extending in the first direction 10x at a distance from each other in the second direction 10y and a second connecting part 18b extending in the second direction 10y. The third extension part 14c extends along the first peripheral edge 12a of the mask body 12, and the fourth extension part 14d extends along the second peripheral edge 12b of the mask body 12. One ends 14q, 16q of the third and fourth extension parts 14c, 16d are bonded, through a second side edge bonded part 22b, to a second side edge part 12q adjoining the fourth peripheral edge 12d of the mask body 12. To the other ends 14t and 16t of the third and fourth extension parts 14c, 16d, the second connecting part 18b is bonded through a second central bonded part 20b. The second connecting part 18b is distinct from the first and second extension parts 14b, 16b.

The first and second side edge bonded parts 22a, 22b and the first and second central bonded parts 20a, 20b are formed by ultrasonic sealing or heat sealing.

The first and second ear hooking parts 11a, 11b are formed of a first extension member 14, a second extension member 16 and a connecting member 18 distinct from one another, and separably connect with each other in the center of the mask body 12 in the first direction 10x.

The first extension member 14 constitutes the first extension part 14a of the first ear hooking part 11a and the third extension part 14b of the second ear hooking part 11b, and is structured so that the other ends 14s, 14t of the first and third extension parts 14a, 14b separably connect with each other in the center of the mask body 12 in the first direction 10x.

The second extension member 16 constitutes the second extension part 16a of the first ear hooking part 11a and the fourth extension part 16b of the second ear hooking part 11b, and is structured so that the other ends 16s, 16t of the second and fourth extension parts 16a, 16b separably connect with each other in the center of the mask body 12 in the first direction 10x.

As shown in FIGS. 1 and 3(a), the first and second extension members 14, 16 are members where first and second elastic members 15, 17 extendable and continuous in the first direction 10x are sandwiched between one nonwoven fabric sheets 50, 52 folded along folding lines 50x, 52x between a pair of side edges 50s, 50t; 52s, 52t. The first and second extension members 14, 16 may be members where the elastic members 15, 17 extendable and continuous in the first direction 10x are sandwiched between two nonwoven fabric sheets as in a second modification described later.

FIGS. 1 and 2 illustrate a case where the side edges 50t, 52t of the extension members 14, 16 are disposed so as to coincide with the peripheral edges 12a, 12b of the mask body 12. The present invention is not limited thereto; the side edges 50t, 52t of the extension members 14, 16 may protrude to the outside of the mask body 12, or the side edges 50t, 52t of the extension members 14, 16 may be situated inside the peripheral edges 12a, 12b of the mask body 12.

The nonwoven fabric sheets 50, 52 and the elastic members 15, 17 are bonded together at some of the plurality of first and second side edge bonded parts 22a, 22b and some of the plurality of first and second central bonded parts 20a, 20b. That is, the elastic members 15, 17 are bonded to the nonwoven fabric sheets 50, 52 at both ends of the extension parts 14a, 14b, and 16a, 16b. The elastic members 15, 17 are rubber threads, shrink films or the like. The elastic members 15, 17 may each be more than one, for example, more than one rubber thread.

The connecting member 18 constitutes the first connecting part 18a of the first ear hooking part 11a and the second connecting part 18b of the second ear hooking part 11b, and is structured so that the first and second connecting parts 18a, 18b separably connect with each other in the center of the mask body 12 in the first direction 10x. That is, adjoining side edges 18m and 18n (see FIGS. 4(a) and 4(b)) of the first and second connecting parts 18a, 18b connect with each other. Side edges 18u, 18v on the opposite sides of the first and second connecting parts 18a, 18b curve so as to be close to each other in the middle part in the second direction 10y.

On the connecting member 18, a perforation 30 and slits 32 are formed that extend in the second direction 10y in the center of the mask body 12 in the first direction 10x. The perforation 30 is a plurality of cuts passing through between the main surfaces of the connecting member 18, and is formed in the middle part of the connecting member 18 in the second direction 10y. The slits 32 are formed on both sides of the perforation 30 so as to align on the same line as the perforation 30. The slits 32 may be formed so as to pass through between the main surfaces of the connecting member 18 or may be formed from one main surface to just before the other main surface of the connecting member 18. The cuts may be formed as appropriate; for example, the perforation 30 may be formed so as to align on the same line as the slit 32 on both sides of the slit 32, or it may be only either one of the perforation 30 and the slit 32 that is formed.

As shown in FIGS. 1 and 2, when the mask 10 in unused state is viewed from a direction vertical to the first and second direction 10x, 10y, ends 18p, 18q; 18s, 18t on both sides of the first and second connecting parts 18a, 18b in the second direction 10y protrude from the mask body 12. This makes it easy to separate the first and second connecting parts 18a, 18b from the mask body 12 and makes it easy to separate the first and second ear hooking parts 11a, 11b. The first and second ear hooking parts 11a, 11b are easily separated also when only either of the ends 18p, 18q and the ends 18s, 18t protrude from the mask body 12. A structure may also be adopted in which both ends 18p, 18q; 18s, 18t of the first and second connecting parts 18a, 18b do not protrude from the mask body 12.

To make it easy to separate the first and third extension parts 14a, 14b and the second and fourth extension parts 16a, 16b, notches, slits or the like may be formed on the first and second extension members 14, 16 or the elastic members 15, 17 may be cut in advance.

As shown in FIGS. 1 and 3(c), when the mask 10 is in unused state, the connecting member 18 is disposed on the side, opposite to the mask body 12, of the first and second extension members 14, 16, and no space is formed between the first and second extension members 14, 16 and the mask body 12. Since the connecting member 18 covers the adjoining ends 14s, 14t of the first and third extension parts 14a, 14b and the adjoining ends 16s, 16t of the second and fourth extension parts 16a, 16b, the external appearance near the center in the first direction 10x is simple. A structure may be adopted in which when the mask 10 is in unused state, the connecting member 18 is disposed on the mask body 12 side of the first and second extension members 14, 16.

When the mask 10 is used, the first and second ear hooking parts 11a, 11b are separated. That is, the connecting member 18 is cut along the perforation 30 and the slits 32 to separate the first and second connecting parts 18a, 18b, the first extension member 14 is cut to separate the first and third extension parts 14a, 14b, and the second extension member 16 is cut to separate the second and fourth extension parts 16a, 16b.

As shown in FIGS. 4(a) and 4(b), in the mask 10 in used state, the first and second ear hooking parts 11a, 11b are separated and developed to the sides opposite to each other toward the outside of the mask body 12 in the first direction 10x, and the first and second ear hooking parts 11a, 11b are folded on the mask body 12. First and second ear hooking holes 13a, 13b surrounded by the first and third extension parts 14a, 14b, the second and fourth extension parts 16a, 16b and the connecting parts 18a, 18b of the first and second ear hooking parts 11a, 11b are defined, and ears are inserted in these first and second ear hooking holes 13a, 13b.

When the mask 10 is worn, since the side edges 18u, 18v of the first and second ear hooking parts 11a, 11b that are along the wearer's ears are curved, the mask 10 is more comfortable to wear than when the side edges 18u, 18v are not curved but linear.

The mask 10 is hygienic because the first and second ear hooking parts 11a, 11b are disposed on the non-skin surface 12s side of the mask body 12 in unused state and for this reason, the mask 10 can be put on without a skin surface 12t of the mask body 12 being touched. A structure may be adopted in which the first and second ear hooking parts 11a, 11b are disposed on the skin surface 12t side of the mask body 12 in unused state.

In the mask 10, since the first and second extension parts 14a, 16a and the first connecting part 18a are distinct from each other and the third and fourth extension parts 14b, 16b and the second connecting part 18b are distinct from each other, an ear hooking part continuous body 56 (described later) for forming the first and second ear hooking parts 11a, 11b can be structured so that the parts where the first and second extension parts 14a, 14b are formed and the parts where the second and fourth extension parts 16a, 16b are formed are continuous. Since the ear hooking part continuous body 56 (described later) structured as describe above can be conveyed at a high speed and does not hinder high-speed production of the mask 10, the mask 10 can be produced at a high speed. Consequently, the number of masks 10 produced per unit time can be increased.

In addition, since the first and second extension parts 14a, 16a and the first connecting part 18a are distinct from each other and the third and fourth extension parts 14b, 16b and the second connecting part 18b are distinct from each other, it is unnecessary to cut the parts corresponding to the entire ear hooking holes 13a, 13b from the material. For this reason, waste of material can be reduced.

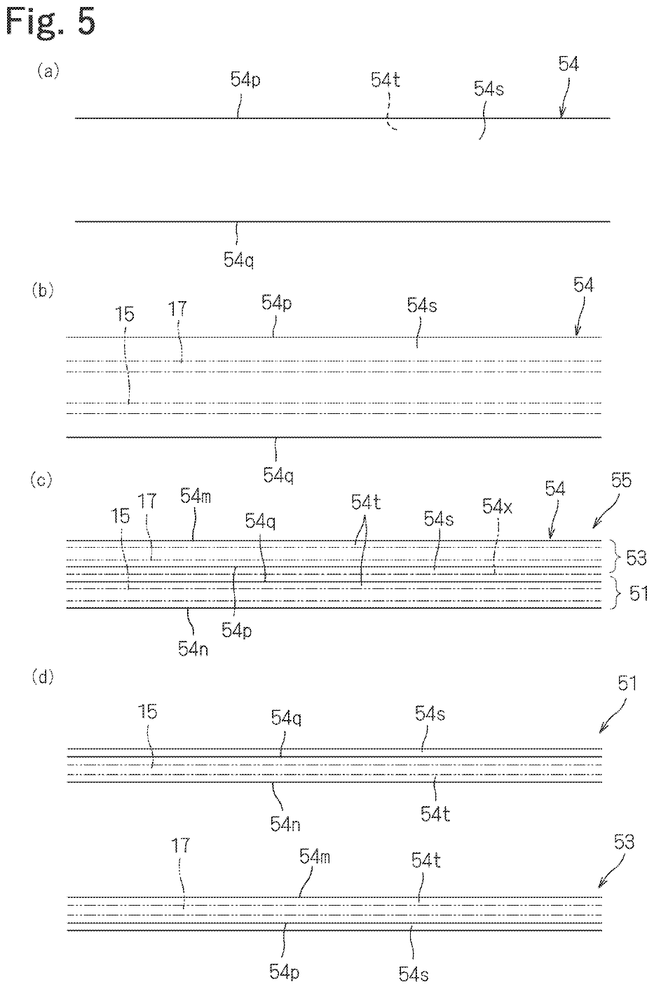

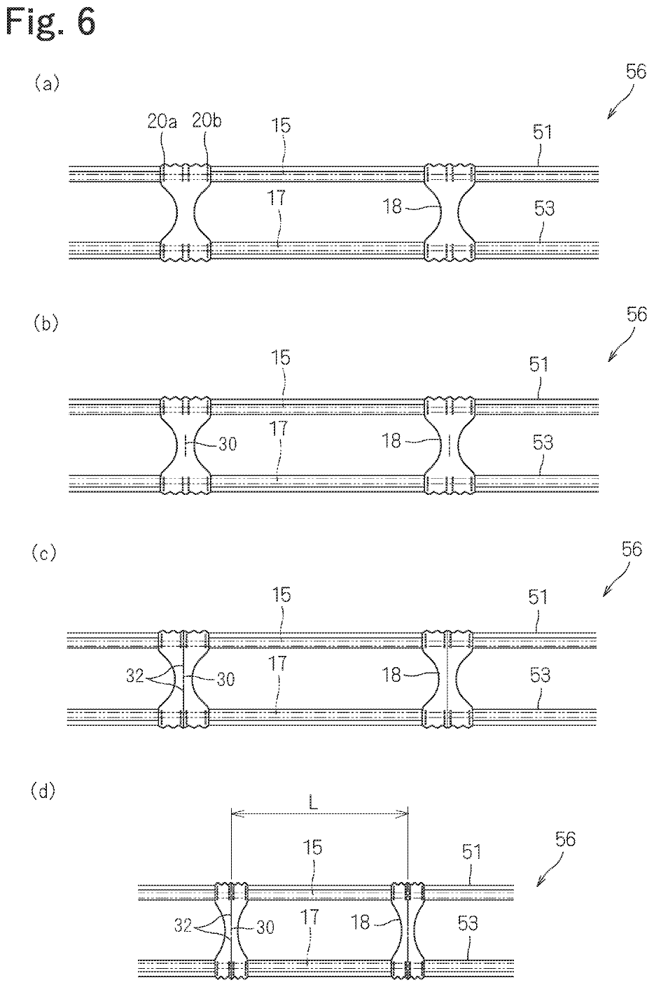

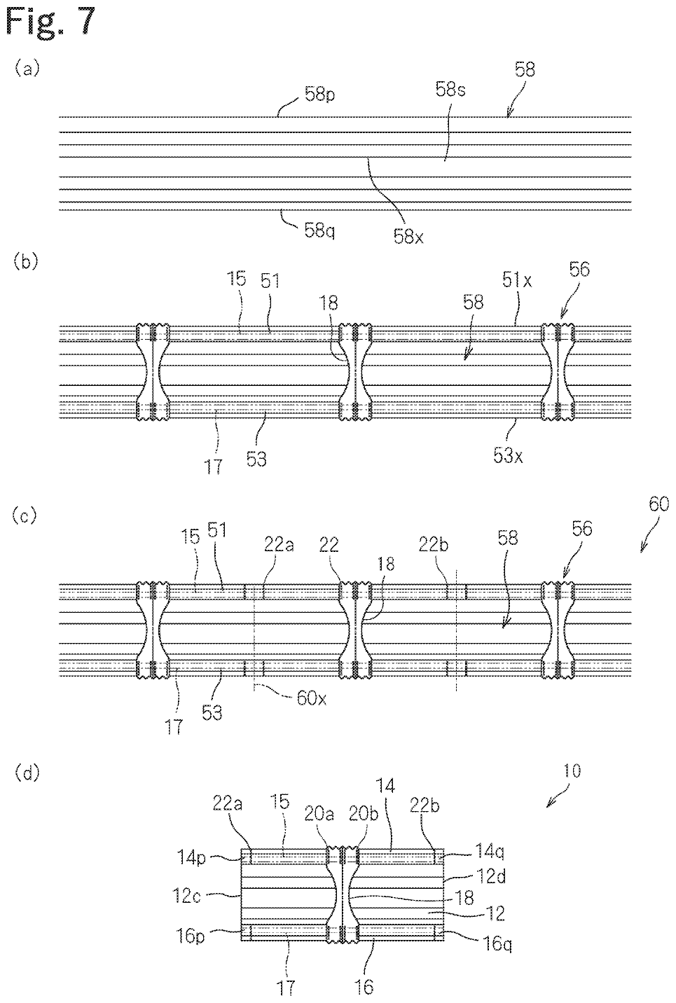

Next, a method for producing the mask 10 will be described with reference to FIGS. 5 to 8(c). FIGS. 5(a) to 5(d) are explanatory views of a process of forming first and second extension part continuous bodies 51, 53. FIGS. 6(a) to 6(d) are explanatory views of a process of forming the ear hooking part continuous body 56. FIGS. 7(a) to 7(d) are explanatory views of a process of forming a mask continuous body 60 to obtain individual masks 10.

The method for producing the mask 10 is roughly provided with first and second processes.

In a first process, as shown in FIG. 7(a), a mask body continuous body 58 having first and second side edges 58p, 58q parallel to each other is conveyed in the direction in which the first and second side edges 58p, 58q extend. The first side edge 58p forms the first peripheral edge 12a of the mask body 12, and the second side edge 58q forms the second peripheral edge 12b of the mask body 12. By cutting the mask body continuous body 58 in a direction intersecting with the first and second side edges 58p, 58q, the third peripheral edge 12c of the mask body 12 and the fourth peripheral edge 12d of another mask body 12 are formed.

For the mask body continuous body 58, for example, while being conveyed, a continuous sheet having one or more than one layer is folded so as to be pleated in such a manner that folding lines 58x extend in the conveyance direction, and then, is integrated by bonding appropriate positions by ultrasonic sealing, heat sealing or the like, thereby forming body bonded parts 12m, 12n, 12u, 12v, 12w (see FIGS. 1, 2, 4(a) and 4(b). Not shown in FIGS. 7(a) to 7(d)).

In a second process, as shown in FIG. 5(d), the first and second extension part continuous bodies 51, 53 each being continuous in one direction are conveyed parallel to each other, at a predetermined distance from each other and at the same speed in the direction in which they are continuous. By cutting the first and second extension part continuous bodies 51, 53 in a direction intersecting with the direction in which they are continuous, one ends 14p and 16p of the first and second extension members 14, 16 and the other ends 14q, 16q of the first and second extension members 14, 16 are formed.

The first and second extension part continuous bodies 51, 53 are produced, for example as shown in FIGS. 5(a) to 5(d), by using one nonwoven fabric sheet 54.

First, as shown in FIG. 5(a), the belt-like nonwoven fabric sheet 54 having a pair of main surfaces 54s, 54t and a pair of side edges 54p, 54q parallel to each other is conveyed in the direction in which the side edges 54p, 54q are continuous.

Then, as shown in FIG. 5(b), on one main surface 54s of the nonwoven fabric sheet 54 being conveyed, the first and second elastic members 15, 17 in stretched state indicated by the chain double-dashed lines are disposed, and conveyed together with the nonwoven fabric sheet 54. The first and second elastic members 15, 17 are disposed parallel to the conveyance direction of the nonwoven fabric sheet 54 at a distance from each other. The elastic members 15, 17 are rubber threads, shrink films or the like. The elastic members 15, 17 may each be more than one, for example, more than one rubber thread.

Then, as shown in FIG. 5(c), the nonwoven fabric sheet 54 is folded along folding lines 54m, 54n so that the side edges 54p, 54q of the nonwoven fabric sheet 54 are disposed on one main surface 54s of the nonwoven fabric sheet 54 at a distance from each other, thereby forming a common continuous body 55 where the elastic members 15, 17 are sandwiched between the nonwoven fabric sheet 54.

Then, as indicated by the chain line 54x in FIG. 5(c), the common continuous body 55 is cut in the conveyance direction between the side edges 54p, 54q of the nonwoven fabric sheet 54 so as to be divided into the first extension part continuous body 51 including the first elastic member 15 and the second extension part continuous body 53 including the second elastic member 17. Then, as shown in FIG. 5(d), the positions of the first and second extension part continuous bodies 51, 53 are changed so that the folding lines 54m, 54n face each other, and the first and second extension part continuous bodies 51, 53 are conveyed at a predetermined distance from each other, parallel to each other and at the same speed.

Forming the first and second extension part continuous bodies 51, 53 by forming and dividing the common continuous body 55 is efficient. However, the first and second extension part continuous bodies 51, 53 may be formed separately.

In a third process, as shown in FIG. 6(a), a plurality of connecting members 18 are bonded to the first and second extension part continuous bodies 51, 53 by ultrasonic sealing, heat sealing or the like so as to straddle between the first and second extension part continuous bodies 51, 53 at a predetermined distance in the direction in which the first and second extension part continuous bodies 51, 53 are conveyed, thereby forming the ear hooking part continuous body 56. The bonding at this time forms the first and second central bonded parts 20a, 20b. Specifically, the following parts are formed: a part where, of the nonwoven fabric sheet 54 forming the first and second extension part continuous bodies 51, 53 and the first and second elastic members 15, 17, only the nonwoven fabric sheet 54 is bonded to the connecting member 18; and a part where the nonwoven fabric sheet 54 and the first or the second elastic member 15 or 17 and the connecting member 18 are bonded together.

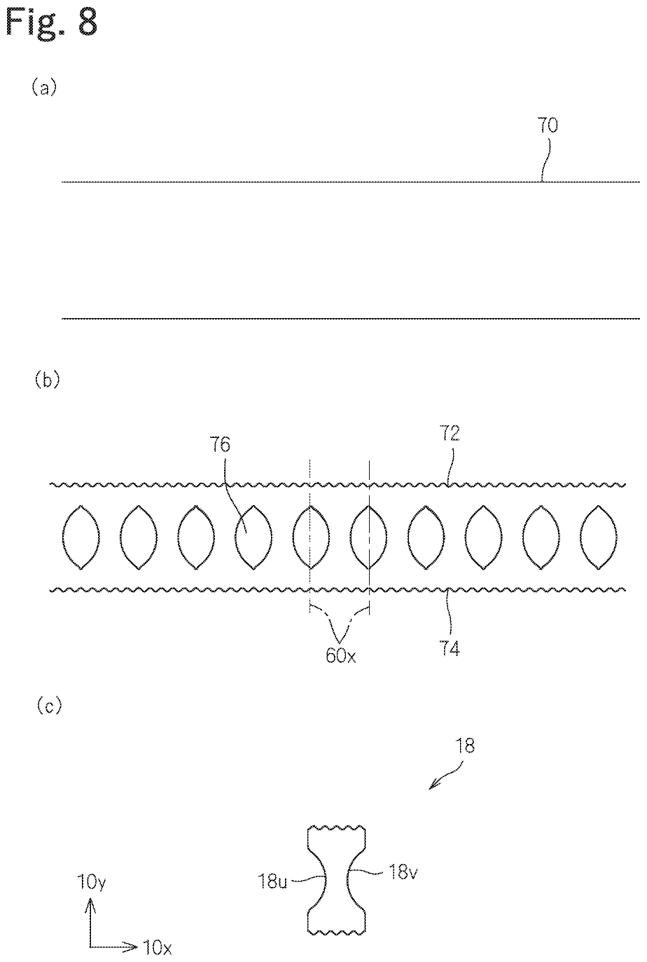

By forming the connecting member 18 by cutting a continuous sheet 70 in a strip shape, for example as shown in FIGS. 8(a) to 8(c), waste of material is less than when the continuous sheet 70 is die-cut one by one. FIGS. 8(a) to 8(c) are explanatory views of a process of forming the connecting member 18. While the belt-like continuous sheet 70 shown in FIG. 8(a) is being conveyed in the length direction, unnecessary parts are cut away to form a pair of side edges 72, 74 and hollow holes 76 as shown in FIG. 8(b). Then, as indicated by the chain lines 60x in FIG. 8(b), the continuous sheet 70 is cut at positions that halve the hollow holes 76, thereby obtaining individual connecting members 18 as shown in FIG. 8(c). Side edges 18u, 18v of the connecting member 18 which are formed by the peripheral edges of the hollow holes 76 are cut in a curved shape so as to be close to each other in the middle part. By successively cutting the continuous sheet 70 in the strip shape and conveying the connecting members 18 obtained by the cutting at predetermined intervals, the connecting members 18 can be bonded to the first and second extension part continuous bodies 51, 53 at predetermined intervals, so that the formation of the continuous sheet can be synchronized with the formation of the ear hooking part continuous body 56.

Then, as shown in FIG. 6(b), the perforation 30 aligned in the direction vertical to the conveyance direction, that is, a plurality of cuts passing through between the main surfaces of the connecting member 18 are formed in the vicinity of the center of the connecting member 18 bonded to the first and second extension part continuous bodies 51, 53.

Then, as shown in FIG. 6(c), the slits 32 are formed on both sides of the perforation 30. The slits 32 may be formed only on the connecting member 18, or may be formed on the connecting member 18 and the first and second extension part continuous bodies 51, 53. The slits 32 may be cuts passing through the connecting member 18 and the first and second extension part continuous bodies 51, 53, or may be cuts formed to the middle without passing through.

The perforation 30 and the slits 32 are formed so that both sides sandwiching the perforation 30 and the slits 32 connect with each other. By forming the perforation 30 and the slits 32 on the connecting member 18, the first and second ear hooking parts 11a, 11b can be easily separated along the perforation 30 and the slits 32.

However, masks may be produced without the formation of the perforation 30 or the slits 32. In that case, the first and second ear hooking parts 11a, 11b connecting with each other are cut, for example, by use of a cutter, a scissors or the like to separate the first and second ear hooking parts 11a, 11b.

Then, as shown in FIG. 6(d), the first and second extension part continuous bodies 51, 53 of the ear hooking part continuous body 56 are contracted in the conveyance direction, thereby releasing the elastic members 15, 17 from the stretched state. By doing this, the distance L between the adjoining connecting members 18 is reduced. Since the first and second extension part continuous bodies 51, 53 have elastic stretchability, the first and second extension part continuous bodies 51, 53 can be contracted.

In a fourth process, as shown in FIG. 7(b), the ear hooking part continuous body 56 and the mask body continuous body 58 both being conveyed are placed one on another so that the first extension part continuous body 51 of the ear hooking part continuous body 56 is along the first side edge 58p of the mask body continuous body 58 and the second extension part continuous body 53 of the ear hooking part continuous body 56 is along the second side edge 58q of the mask body continuous body 58, and as shown in FIG. 7(c), in the middle between the adjoining connecting members 18, the first and second extension part continuous bodies 51, 53 of the ear hooking part continuous body 56 and the mask body continuous body 58 are bonded together by ultrasonic sealing, heat sealing or the like, thereby forming the mask continuous body 60. The bonding at this time forms the first and second side edge bonded parts 22a, 22b. Specifically, the following parts are formed: parts where, of the nonwoven fabric sheet 54 constituting the first extension part continuous bodies 51, 53 of the ear hooking part continuous body 56 and the first and second elastic members 15, 17, only the nonwoven fabric sheet 54 is bonded to the mask body continuous body 58; and parts where the nonwoven fabric sheet 54 and the first or the second elastic member 15 or 17 are bonded to the mask body continuous body 58.

When the extension part continuous bodies 51, 53 of the ear hooking part continuous body 56 and the mask body continuous body 58 are placed one on another, the side edges 51x, 53x on the opposite sides of the extension part continuous bodies 51, 53 (see FIG. 7(b)) may coincide with the side edges 58p, 58q of the mask body continuous body 58 (see FIG. 7(a)), may protrude to the outside of the mask body continuous body 58, or may be situated inside the side edges 58p, 58q of the mask body continuous body 58.

In a fifth process, the mask continuous body 60 being conveyed is cut in a direction intersecting with (for example, a direction orthogonal to) the direction in which the mask continuous body 60 is conveyed as indicated by the chain lines 60x in FIG. 7(c), thereby obtaining individual masks 10 as shown in FIG. 7(d).

By cutting the mask body continuous body 58 of the mask continuous body 60, the third and fourth peripheral edges 12c, 12d of the mask body 12 are formed. By cutting the first and second extension part continuous bodies 51, 53 of the mask continuous body 60, the first and second extension members 14, 16 of the mask body 12 are formed.

When the first and second elastic members 15, 17 are released from the stretched state in the fourth process, in the fifth process, the mask 10 in flat state is obtained where the first and second extension members 14, 16 having stretchability are disposed along the mask body 12.

By producing the mask 10 by the above-described method, the ear hooking part continuous body 56 where the first and second extension part continuous bodies 51, 53 are continuous can be conveyed at a high speed, so that the mask 10 can be produced at a high speed. In addition, the ear hooking part continuous body 56 can be formed without cutting away the parts corresponding to the entire ear hooking holes 13a, 13b, so that waste of material can be reduced.

The first and second extension part continuous bodies 51, 53 may be provided with stretchability in the direction in which the first and second extension part continuous bodies 51, 53 are conveyed, by being drawn in the direction in which the first and second extension part continuous bodies 51, 53 are conveyed prior to the fourth process. For the drawing, for example, the first and second extension part continuous bodies 51, 53 or the ear hooking part continuous body 56 is conveyed while sandwiched between a pair of rolls having uneven outer peripheral surfaces engaging with each other.

In this case, it is unnecessary that the first and second elastic members 15, 17 be in stretched state in the second and third processes, and it is unnecessary to contract the first and second extension part continuous bodies 51, 53 of the ear hooking part continuous body 56 in the conveyance direction prior to the fourth process.

### First Modification

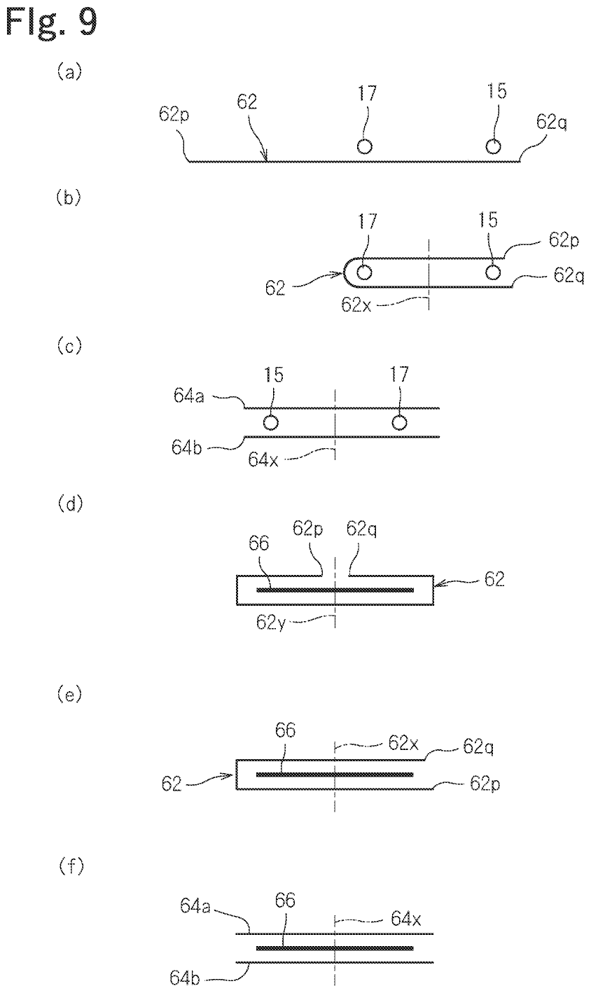

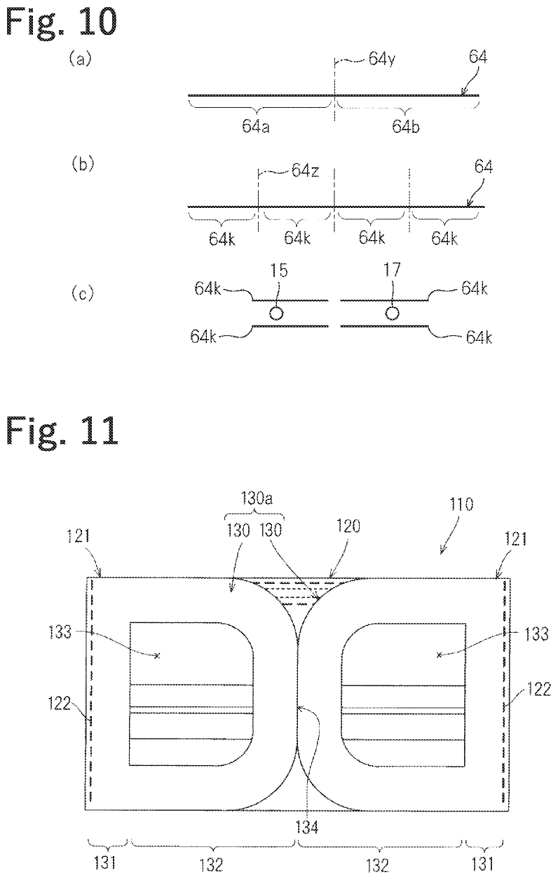

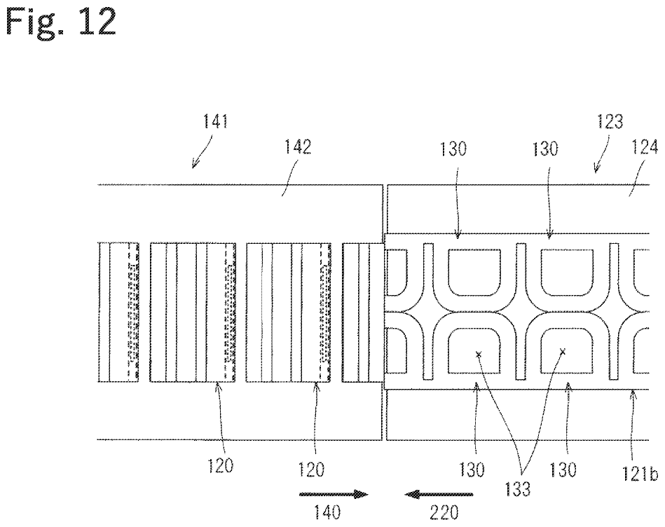

FIGS. 9(a) to 9(f) and 10(a) to 10(c) are explanatory views showing a first modification of the process of forming the first and second extension part continuous bodies, and are schematic views of the cross section in the width direction.

The first and second extension part continuous bodies may be formed as follows: As shown in FIG. 9(a), the first and second elastic members 15, 17 are disposed on the one side edge 62q side of one nonwoven fabric sheet 62, then, as shown in FIG. 9(b), the other side edge 62p side of the nonwoven fabric sheet 62 is folded to sandwich the first and second elastic members 15, 17 between the nonwoven fabric sheet 62, and the nonwoven fabric sheet 62 is cut between the first and second elastic members 15, 17 as indicated by the chain line 62y.

The first and second extension part continuous bodies may be formed as follows: As shown in FIG. 9(c), the first and second elastic members 15, 17 are sandwiched between two nonwoven fabric sheets 64a, 64b, and the nonwoven fabric sheets 64a, 64b are cut between the first and second elastic members 15, 17 at the position indicated by the chain line 64x. In this case, two nonwoven fabric sheets 64a, 64b may be used that are obtained by cutting and dividing one sheet of nonwoven fabric continuous web 64 in the length direction at the position indicated by the chain line 64y as shown in FIG. 10(a).

The first and second extension part continuous bodies may be formed as follows: As shown in FIG. 9(d), an elastic member 66 is sandwiched between one nonwoven fabric sheet 62 folded at one side edge 62p side and the other side edge 62q side, and the nonwoven fabric sheet 62 and the elastic member 66 are cut and divided at the position indicated by the chain line 62y.

The first and second extension part continuous bodies may be formed as follows: As shown in FIG. 9(e), the elastic member 66 is sandwiched between one nonwoven fabric sheet 62 folded at the one side edge 62q side to the other side edge 62p side, and the nonwoven fabric sheet 62 and the elastic member 66 are cut and divided at the position indicated by the chain line 62x.

The first and second extension part continuous bodies may be formed as follows: As shown in FIG. 9(f), the elastic member 66 is sandwiched between two nonwoven fabric sheets 64a, 64b, and the nonwoven fabric sheets 64a, 64b and the elastic member 66 are cut and divided at the position indicated by the chain line 64x. In this case, two nonwoven fabric sheets 64a, 64b may be used that are obtained by cutting and dividing one sheet of nonwoven fabric continuous web 64 in the length direction at the position indicated by the chain line 64y as shown in FIG. 10(a).

The first and second extension part continuous bodies may be formed as follows: As shown in FIG. 10(b), one sheet of nonwoven fabric continuous web 64 is cut in the length direction at three positions indicated by the chain lines 64z to form four nonwoven fabric sheets 64k, and then, as shown in FIG. 10(c), the first and second elastic members 15, 17 are each sandwiched by two of the sheets 64k.

### Second Modification

When a mask is produced where rubber threads are disposed as the elastic members 15, 17 on the extension member 14, 16 constituting the extension parts 14a, 14b; 16a, 16b, first and second extension part continuous bodies 51, 53 may be formed as follows: The rubber threads are stretched, and with the rubber threads being sandwiched between nonwoven fabric sheets, the rubber threads and the nonwoven fabric sheets are intermittently fused in the conveyance direction by ultrasonic waves or heat. In this case, it is unnecessary to bond the rubber threads and the nonwoven fabric sheets together in the first and second side edge bonded parts 22a, 22b and the first and second central bonded parts 20a, 20b.

### Summary

According to the mask and the method for producing the mask described above, waste of material can be reduced, and the mask can be produced at a high speed.

The present invention is not limited to the above-described embodiment but may be carried out with various modifications being added.

For example, the mask of the present invention may be produced by a method other than the above-described method. The mask body may have a shape other than a rectangle. For example, the angle between the first and second peripheral edges and the third and fourth peripheral edges of the mask body may be either an acute angle or an obtuse angle. Moreover, the peripheral edge of the mask body may be curved, or may has a shape where folded parts and/or curved parts are repeated.

### DESCRIPTION OF REFERENCE NUMERALS

10 Mask
10x First direction
10y Second direction
11a, 11b Ear hooking part
12 Mask body
12a to 12d Peripheral edge
12p, 12q Side edge part
12s Non-skin surface
12t Skin surface
13a, 13b Ear hooking hole
14 First extension member (member)
14a First extension part
14b Third extension part
14p, 14q End
14s, 14t End
15 First elastic member
16 Second extension member (member)
16a Second extension part
16b Fourth extension part
16p, 16q One end
16s, 16t The other end
17 Second elastic member
18 Connecting member
18a, 18b Connecting part
18p, 18q End on the same side
18s, 18t End on the same side
30 Perforation (cut)
32 Slit (cut)
50 Nonwoven fabric sheet
51 First extension part continuous body
52 Nonwoven fabric sheet
53 Second extension part continuous body
55 Common continuous body
56 Ear hooking part continuous body
58 Mask body continuous body
58p, 58q Side edge
60 Mask continuous body

1. A mask comprising:
a mask body having first and second peripheral edges extending in a first direction and third and fourth peripheral edges extending in a second direction intersecting with the first direction;
a first ear hooking part bonded to a first side edge part adjoining the third peripheral edge of the mask body; and
a second ear hooking part bonded to a second side edge part adjoining the fourth peripheral edge of the mask body,
wherein the first ear hooking part has:
first and second extension parts one ends of which are bonded to the first side edge part and that extend in the first direction along the first peripheral edge or the second peripheral edge at a distance from each other in the second direction;
a first connecting part distinct from the first and second extension parts, the first connecting part being bonded to the other ends of the first and second extension parts and extending in the second direction, and
the second ear hooking part has:
third and fourth extension parts one ends of which are bonded to the second side edge part and that extend in the first direction along the first peripheral edge or the second peripheral edge at a distance from each other in the second direction; and
a second connecting part distinct from the third and fourth extension parts, the second connecting part being bonded to the other ends of the third and fourth extension parts and extending in the second direction,
a first ear hooking hole surrounded by the first and second extension parts and the first connecting part of the first ear hooking part is defined, and
a second ear hooking hole surrounded by the third and fourth extension parts and the second connecting part of the second ear hooking part is defined.

2. The mask according to claim 1, wherein in the mask, in unused state,
the other end of the first extension part of the first ear hooking part and the other end of the third extension part of the second ear hooking part separably connect with each other in a center of the mask body in the first direction,
the other end of the second extension part of the first ear hooking part and the other end of the fourth extension part of the second ear hooking part separably connect with each other in the center of the mask body in the first direction,
the first connecting part of the first ear hooking part and the second connecting part of the second ear hooking part separably connect with each other in the center of the mask body in the first direction, and
when the mask is used, the first and second ear hooking parts are separated in the center of the mask body in the first direction.

3. The mask according to claim 1, wherein in the mask, in unused state, the first and second ear hooking parts are disposed on a non-skin surface side of the mask body.

4. The mask according to claim 1, wherein in the mask, in unused state, when viewed from a third direction vertical to the first and second directions, ends, on the same side in the second direction, of the first connecting part of the first ear hooking part and the second connecting part of the second ear hooking part protrude from the mask body.

5. The mask according to claim 1, wherein in the mask, in unused state,
the first connecting part of the first ear hooking part is disposed on a side, opposite to the mask body, of the first and second extension parts of the first ear hooking part, and
the second connecting part of the second ear hooking part is disposed on a side, opposite to the mask body, of the third and fourth extension parts of the second ear hooking part.

6. The mask according to claim 1, wherein in the mask, in unused state, the first and second ear hooking parts connect with each other in the center of the mask body in the first direction, and
in the mask, in used state, the first and second ear hooking parts are separated in the center of the mask body in the first direction, and folded to the outside of the mask body in the first direction.

7. The mask according to claim 1, wherein
the first and second extension parts of the first ear hooking part and the third and fourth extension parts of the second ear hooking part are each formed of a member where an elastic member stretchable in the first direction is sandwiched between two nonwoven fabric sheets or between one folded nonwoven fabric sheet.

8. A method for producing a mask comprising:
a mask body having first and second peripheral edges extending in a first direction and third and fourth peripheral edges extending in a second direction intersecting with the first direction;
a first ear hooking part bonded to a first side edge part adjoining the third peripheral edge of the mask body; and
a second ear hooking part bonded to a second side edge part adjoining the fourth peripheral edge of the mask body,
wherein the first and second ear hooking parts are formed of:
first and second extension members that extend along the first peripheral edge or the second peripheral edge at a distance from each other in the second direction, one ends of which are bonded to the first side edge part of the mask body and the other ends of which are bonded to the second side edge part of the mask body; and
a connecting member distinct from the first and second extension members, the connecting member extending in the second direction in a center of the mask body in the first direction and being bonded to the first and second extension members, and
first and second ear hooking holes surrounded by the first and second extension members and the connecting member are defined,
the method comprising:
a first process in which a mask body continuous body having first and second side edges parallel to each other and where the first peripheral edge of the mask body is formed by the first side edge, the second peripheral edge of the mask body is formed by the second side edge and by cutting in a direction intersecting with the first and second side edges, the third peripheral edge of the mask body and the fourth peripheral edge of another mask body are formed simultaneously, is conveyed in a direction in which the first and second side edges extend;
a second process in which first and second extension part continuous bodies each being continuous in one direction and where by cutting in a direction intersecting with the one direction, the one ends of the first and second extension members and the other ends of other first and second extension members are formed simultaneously, are conveyed in the one direction parallel to each other at predetermined intervals;
a third process in which a plurality of connecting members are bonded to the first and second extension part continuous bodies at a predetermined interval in a direction in which the first and second extension part continuous bodies are conveyed, so as to straddle between the first and second extension part continuous bodies being conveyed, thereby forming an ear hooking part continuous body;
a fourth process in which the ear hooking part continuous body and the mask body continuous body both being conveyed are placed one on another so that the first extension part continuous body of the ear hooking part continuous body is along the first side edge of the mask body continuous body and the second extension part continuous body of the ear hooking part continuous body is along the second side edge of the mask body continuous body and the first and second extension part continuous bodies of the ear hooking part continuous body and the mask body continuous body are bonded together in the middle between the adjoining connecting members, thereby forming a mask continuous body; and
a fifth process in which the mask continuous body being conveyed is cut in a direction intersecting with the direction in which the mask continuous body is conveyed, thereby obtaining individual masks.

9. The method for producing the mask according to claim 8, wherein in the third process, the first and second extension part continuous bodies having elastic stretchability are conveyed in a state of being stretched in the direction in which the first and second extension part continuous bodies are conveyed, and
in the fourth process, the first and second extension part continuous bodies of the ear hooking part continuous body are conveyed in a state of being contracted in the direction in which the first and second extension part continuous bodies are conveyed.

10. The method for producing the mask according to claim 8, wherein the first extension part continuous body has:
between two nonwoven fabric sheets continuous in the direction in which the first extension part continuous body is conveyed or one folded nonwoven fabric sheet; and
a first elastic member sandwiched between the two nonwoven fabric sheets or between the one folded nonwoven fabric sheet and stretchable and continuous in the direction in which the first extension part continuous body is conveyed, and
the second extension part continuous body has:
between other two nonwoven fabric sheets continuous in the direction in which the second extension part continuous body is conveyed or other one folded nonwoven fabric sheet; and
a second elastic member sandwiched between the two other nonwoven fabric sheets or between the other one folded nonwoven fabric sheet and stretchable and continuous in the direction in which the second extension part continuous body is conveyed.

11. The method for producing the mask according to claim 8, wherein the first extension part continuous body has:
between two nonwoven fabric sheets continuous in the direction in which the first extension part continuous body is conveyed or one folded nonwoven fabric sheet; and
a first elastic member sandwiched between the two nonwoven fabric sheets or between the one folded nonwoven fabric sheet and continuous in the direction in which the first extension part continuous body is conveyed,
the second extension part continuous body has:
between other two nonwoven fabric sheets continuous in the direction in which the second extension part continuous body is conveyed or other one folded nonwoven fabric sheet; and
a second elastic member sandwiched between the two other nonwoven fabric sheets or between the other one folded nonwoven fabric sheet and continuous in the direction in which the second extension part continuous body is conveyed, and
prior to the fourth process,
the first extension part continuous body is drawn in the direction in which the first extension part continuous body is conveyed, and is provided with stretchability in the direction in which the first extension part continuous body is conveyed, and
the second extension part continuous body is drawn in the direction in which the second extension part continuous body is conveyed, and is provided with stretchability in the direction in which the second extension part continuous body is conveyed.

12. The method for producing the mask according to claim 8, wherein the first and second extension part continuous bodies conveyed in the second process are formed as follows:
the first and second elastic members are sandwiched between the continuous two nonwoven fabric sheets or between one nonwoven fabric sheet folded and continuous in a direction of a folding line, at a distance from each other so as to be continuous in a direction in which the two nonwoven fabric sheets or the one nonwoven fabric sheet is continuous, thereby forming a common continuous body, and the common continuous body is cut in the direction in which the first and second elastic members are continuous between the first and second elastic members so as to be divided into the first extension part continuous body including the first elastic member and the second extension part continuous body including the second elastic member.

13. The method for producing the mask according to claim 10, wherein the first and second elastic members are rubber threads or shrink films.

14. The method for producing the mask according to claim 8, wherein the connecting member is formed by cutting a continuous sheet into a strip shape.

15. The method for producing the mask according to claim 14, wherein the connecting member is previously cut in a curved shape so that an external shape on both sides of the connecting member in the first direction is close to each other in a middle part in the second direction.

16. The method for producing the mask according to claim 8, wherein after the third process and prior to the fourth process, in a middle part of the connecting member in a direction in which the connecting member is conveyed together with the first and second extension part continuous bodies, a cut is formed in a direction orthogonal to the direction.

17. The method for producing the mask according to claim 16, wherein the cut includes a perforation formed in a middle part of the connecting member in the second direction.
